(19) United States
(12) Patent Application Publication
(10) Pub. No.: US 2021/0375249 A1
(43) Pub. Date: Dec. 2, 2021

(54) PARTIALLY OR MAINLY ENCLOSED PASSIVE VOCAL, VOICE, OR SOUND APPARATUS, METHOD AND SYSTEM TO ALTER AND YIELD EFFECTS ON SOUND

(71) Applicant: NEAL VIACAVA, Washington Crossing, PA (US)

(72) Inventor: NEAL VIACAVA, Washington Crossing, PA (US)

(21) Appl. No.: 15/929,983

(22) Filed: Jun. 1, 2020

(51) Int. Cl. G10K 11/00

(52) U.S. Cl. CPC G10K 11/00

(57) ABSTRACT

A partially or mainly enclosed passive apparatus, inclusive of a method and system to be used with input sounds, possibly vocals or voice, to alter and yield different and various effects to the sound being input. The passive apparatus is comprised of an exterior shell and removable enclosure structure, both of a shape, contour, and dimensions to be effective in containing a level of sound being input. Additionally, the apparatus may employ a variety of permanent, removable, relocatable solid shapes to yield desired effects of the user.

### BACKGROUND OF THE INVENTION

The invention relates generally to passive apparatus and devices possessing the ability to alter or have an effect on the input sound. More specifically, the invention relates to a partially or mainly enclosed structure employing a method and system inclusive of a variety of solid shapes, contours and configurations to alter and yield effects on input vocals, voice, or sound.

### RELATED ART

Prior partially or mainly enclosed active and passive devices, apparatus and methods have been formulated mainly for use during sessions of training, practicing or rehearsing vocal or voice techniques. The prior active forms of the art are designed to employ electronics and circuitry to give a user effects or alterations to the sound being input. Additionally, the prior passive forms of the art are comprised of devices and apparatus which are designed to merely transfer contained sound, or reflect sound back to the user without possessing the design or capabilities of altering or yielding changes or effects to the sound, beyond that of hearing it at a differed level of volume as compared to when not employing the device or apparatus.

Accordingly, there are benefits to a partially or mainly enclosed vocal, voice, or sound apparatus, inclusive of a method and system, which does not require the complexity of any electronic components, yet is designed to alter and yield effects to the sound being input.

### SUMMARY OF THE INVENTION

The subject invention comprises a partially or mainly enclosed passive apparatus, inclusive of a method and system to alter and yield effects to the sound being input. The passive apparatus is comprised of an exterior shell of a shape and dimensions to be effective in containing a level of sound being input. Additionally, the apparatus may contain permanent contours, shapes, and dimensions to yield the desired effects of the user. The subject apparatus may be used with a system of various attachable and removable solid shapes capable of yielding effects to the input sound. Additionally, the apparatus may be connected to an enclosure structure to further contain the input sound.

Further, the method employed by the invention is to yield effects to the sound being input to a partially or mainly enclosed passive apparatus, inclusive of a system of various contours along with a variety of permanent and/or removable and relocatable solid shapes. By positioning and connecting the solid shapes in different configurations in relation to the exterior shell and/or the enclosure structure, alterations and effects will be yielded to the input sounds. The effects to the sound may include but are not limited to, dividing, diffracting, diffusing, refracting, and absorbing.

### BRIEF DESCRIPTION OF THE DRAWINGS

The drawings described herein are for illustration purposes only and are not intended to limit the scope of the present disclosure in any way.

FIG. 1 is a view showing the interior of both the shell structure 100, inclusive of an example dimension, contour, and configuration 114, along with the unattached enclosure structure 120. The enclosure structure 120 contains a main portal 124 for the user to input sound, along with two side openings 122 for attachment of, or positioning of, a listening or sound receiving device (not shown). An example of a permanent contour, shape, and configuration 114 is exhibited. In the invention's mainly enclosed configuration, sides 110 & 116 would be in contact, as well as, sides 112 & 114. As an example of how the invention can be supported, the shell structure 100 is shown on a pole 116 and base 118 setup.

FIG. 2 is a partial assortment of examples of the types and variations of the solid shapes 200-206 available for use with the apparatus.

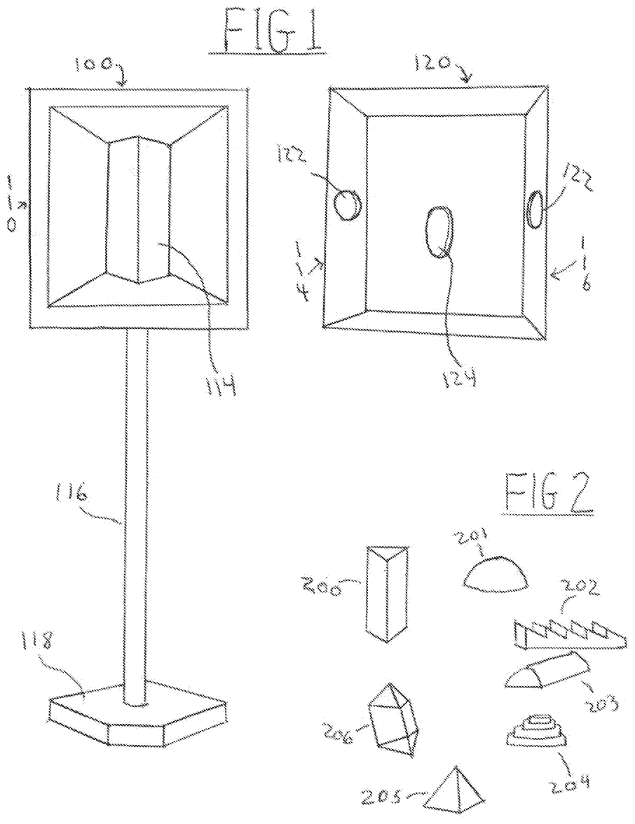

### DETAILED DESCRIPTION OF THE PREFERRED EMBODIMENT

The subject invention comprises a partially or mainly enclosed passive apparatus, inclusive of a method and system to alter and yield different and various effects to the sound being input. The passive apparatus is comprised of an exterior shell of a shape, contour, and dimensions to be effective in containing a level of sound being input. Such shell can be made of any effective material, to include but not limited to plastics, metals, rubbers, ceramics or woods. Additionally, the apparatus may contain permanent design shapes and contours to yield desired effects of the user.

Further, the method employed by the invention is to yield different and various effects to the sound being input to a partially or mainly enclosed passive apparatus, inclusive of a system of various permanent and/or removable solid shapes. The different and various effects to the sound may include but are not limited to, dividing, diffraction, diffusion, absorption and refraction.

Additionally, this passive apparatus when used in its' open configuration, will have an effect on lowering ambient noise and sounds. This apparatus may be used with a system of various attachable and removable solid shapes capable of yielding the different and various effects to the input sound. Materials used in these component shapes may include, but are not limited to, plastics, metals, rubbers, ceramics, woods or foams. Means of attaching the solid shape components may include, but are not limited to, adhesives, suction devices, Velcro, slot and tab configurations.

The apparatus, although normally positioned on a stand, post or other flat surface, may be handled by the user if desired.

The invention during use will have a source to input sound, often but not always a person, that will be positioned toward the opening side of the partially or mainly enclosed shell structure. It is not necessary to be in, or remain in, one position relative to the apparatus, since shifting positions can yield another level of variation and different effect on the sound in conjunction with the existing configuration of the apparatus and its' solid shape components. Additionally, by shifting position it can further contribute to the desired effect on the sound being heard by the user. The user can use the apparatus, method and system to alter, adjust and change the effect on the sound by the insertion, removing or repositioning of the component shapes relative to the partially or mainly enclosed shell structure.

The two main configurations of the apparatus include having the enclosure piece 120 separate from the partially enclosed shell structure 100. The second configuration is with the enclosure piece 120 attached to the partially enclosed shell structure 100. This is accomplished by connecting the side 110 to side 116, along with side 112 to side 114, thereby forming a mainly enclosed structure. The enclosure piece 120 contains several openings. The middle opening 124 is for sound or voice input. The two openings 122 on either side of the enclosure piece are for connecting optional attachments to provide direct listening to the user or other receiving entity (i.e. microphone or recorder). Absent of any attachments to the side openings 122, a microphone or recording device may be positioned to capture the vocals, voice, or sounds being emitted.

What is claimed is:

1. An apparatus comprising any feature described, either individually or in combination with any feature, in any configuration. Or a process to alter or have an effect on sound comprising any process described, in any order, and using any modality.

2. A passive apparatus comprising a shell and removable enclosure piece which forms a partially or mainly enclosed structure, depending on the position of the enclosure piece.

3. Said passive apparatus and structure of claim 1, comprising of permanent contour to be used in conjunction with a variety of removable, relocatable solid shapes or shape to alter and yield effects to vocals, voices, or sounds input.

4. The solid shapes of claim 3, comprising the ability of being of a permanent, removable, or relocatable nature.

5. The solid shapes of claim 3, comprising any geometric shape or geometric shapes, either alone or in combination to be effective in altering or having an effect on input sound.

6. A method for providing an ability to alter or yield effects on vocals, voice, or sounds comprising a partially or mainly enclosed structure in conjunction with contours, shapes, and configurations.

7. The shapes of claim 4, comprising the ability of being a permanent component of the apparatus of claim 1, or being inserted temporarily to form different configurations of the same apparatus of claim 1.

8. An enclosure component of claim 1, comprising openings for input of vocals, voice, or sounds.

9. An enclosure component of claim 1, comprising openings for the altered or effected input vocals, voice, or sounds to be heard.

10. An enclosure component of claim 1, comprising openings for an attachment for conveying the altered or effected vocals, voice, or sound directly to a receiving entity.

11. A passive apparatus of claim 1, which can be supported by various means including supporting structures or manually by a user.
